(19) United States
(12) Patent Application Publication
(10) Pub. No.: US 2026/0326964 A1
(43) Pub. Date: Oct. 22, 2026

(54) AN APPLICATOR PAD ASSEMBLY

(71) Applicant: Dover Europe Sàrl, Vernier (SE)

(72) Inventor: Jonas Södergård, Vastra Frolunda (SE)

(21) Appl. No.: 19/100,492

(22) PCT Filed: Aug. 1, 2023
(86) PCT No.: PCT/EP2023/071340

§ 371 Date: Jan. 31, 2025

(30) Foreign Application Priority Data
Aug. 1, 2022 (SE) 2250937-6
Aug. 1, 2022 (SE) 2250938-4
Aug. 1, 2022 (SE) 2250939-2
Aug. 1, 2022 (SE) 2250940-0
Aug. 1, 2022 (SE) 2250941-8
Aug. 1, 2022 (SE) 2250942-6
Aug. 1, 2022 (SE) 2250943-4
Aug. 1, 2022 (SE) 2250944-2

(51) Int. Cl. B65C 9/36

(52) U.S. Cl. CPC B65C 9/36

(57) ABSTRACT

The specification discloses label applicator pad assembly (100, 100′) comprising: an applicator pad (110,110′), a support structure (120, 450), a joint (150, 400) provided between the support structure and the applicator pad, and a mechanism operable between the applicator pad and the support structure and actionable in a direction opposite to the joint configured to provide a home position for the applicator pad.

### TECHNICAL FIELD

The disclosure relates generally to an applicator assembly for receiving a label to be applied on a surface and an applicator pad assembly in particular. In particular aspects, the disclosure relates to a label applicator pad that can apply a label on several types of surfaces. The assembly of the disclosure can be used in industrial applications in general and print and apply system applications in particular.

### BACKGROUND

In many production sites, such as those involving the handling of goods on pallets, it is common to use pallet labels to convey information about the identity and destination of the pallets.

In certain situations, the labels can be printed and applied automatically. This is often the case in production plants where large quantities of goods are produced, as well as in automated warehouses where pallets are received, stored, and shipped out. Particularly in the latter case, the shape and size of the pallets can vary depending on the contents they hold.

A challenge faced by automated label applicators is the reliable application of labels on uneven surfaces. Typically, a label is held in place by a label pad during the application process. To ensure adaptability to uneven surfaces, the label application pad needs to be adjustable in one or several directions, such as:
Movement towards or away from the target.
Forward or backward leaning.
Clockwise or counter clockwise twisting.

The first type of adjustment is often accomplished by the movement of the label applicator itself, which can be either linear or rotational. The second and third adjustments are commonly achieved using spring-loaded designs provided on the applicator pad.

An additional challenge for adjustable label applicator pad designs arises when the pad is in a stable home position and not pressed against the application target. This home position is crucial to reliably feed the label onto the label pad.

Several existing solutions address the conception of a stable home position, such as:
Surfaces being pressed against each other, sometimes with mechanical guidance, such as pins through holes, against a single surface.
Utilizing the rigidity of a spring to establish a natural home position.

Moreover, when designing a label applicator for a linear movement that is not using compressed air, e.g., for sustainability reasons, or any fans on the moving parts, for weight and simplicity reasons, there is a need for an adaptable joint, e.g., with the following characteristics:
Stable position in all directions when not compressed.
Adaptable to uneven surfaces when compressed.
Transports air with low flow resistance without leakage.
Easy and cheap to produce.
Has a low weight.

### SUMMARY

The intention of this disclosure is to provide an effective applicator pad assembly that solves the previously mentioned drawbacks and provide an applicator pad assembly which allows a reliable application of labels on uneven surfaces.

According to a first aspect of the disclosure to achieve the objectives a label applicator pad assembly is provided, comprising: an applicator pad, a support structure, a joint provided between the support structure and the applicator pad, and a mechanism operable between the applicator pad and the support structure and actionable in a direction opposite to the joint configured to provide a home position for the applicator pad.

The above aspects, accompanying claims, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein. There are also disclosed herein control units, computer readable media, and computer program products associated with the above discussed technical benefits.

### BRIEF DESCRIPTION OF THE DRAWINGS

With reference to the appended drawings, below follows a more detailed description of aspects of the disclosure cited as examples. Reference is made to the attached drawings, wherein elements having the same reference number designation may represent like elements throughout.

FIG. 1 illustrates, in a side view, an exemplary applicator pad as described in the present disclosure;

FIG. 2 illustrates, in a side view, a part of the exemplary applicator pad of FIG. 1;

FIG. 3 illustrates an exemplary outer arm with parts removed and the applicator pad of FIG. 1, in a view from behind;

FIG. 4 is a cross-sectional view of an exemplary joint for an applicator pad;

FIG. 5 is a schematical sectional view of the joint of FIG. 4 connected to an applicator pad; and

FIG. 6 is a schematical view of the joint of FIG. 4 and the applicator pad assembly.

### DETAILED DESCRIPTION

The term “industrial printer,” also known as an “industrial-grade printer,” as used herein, may refer to a type of printer specifically designed for heavy-duty printing tasks in industrial environments. These types of printers are built to manage large volumes of printing, often with high-speed and precision, and are capable of printing on various materials such as paper, cardboard, labels, plastics, and metals. The industrial printers, as referred to herein, may commonly be used in sectors like manufacturing, logistics, packaging, and retail, where there is a need for efficient and reliable printing solutions. They are typically more robust and durable compared to standard office printers, as they are required to withstand harsher conditions and extended operation periods.

Industrial printers may also incorporate additional features, such as advanced connectivity options, rugged enclosures, automatic label applicators, or integrated systems for data management and control. These features enhance their productivity, efficiency, and integration with other industrial processes.

The term “label,” as used herein, may include an information carrier media which can be made of several types of materials, depending on the specific requirements and application. Some common materials used for printer labels may for example include (but not limited to): paper, synthetic materials, cardstock, clear and transparent materials, thermal labels, and specialty materials.

The term “arm,” as used herein, may refer to a substantially oblong construction, which in some designs may comprise a connected portion.

In the following disclosure, references may be made to “print and apply” applications, i.e., applications in which a printer, especially a label printer and in particular an industrial label printer, prints on a label carried on a backing paper and dispenses it to an applicator, which applies the label on a product. However, the applicator may likewise be in communication with a dispenser, dispensing preprinted labels.

The present disclosure provides a solution in label applicators in general and automated label applicators in particular for a reliable application of labels, especially on uneven surfaces.

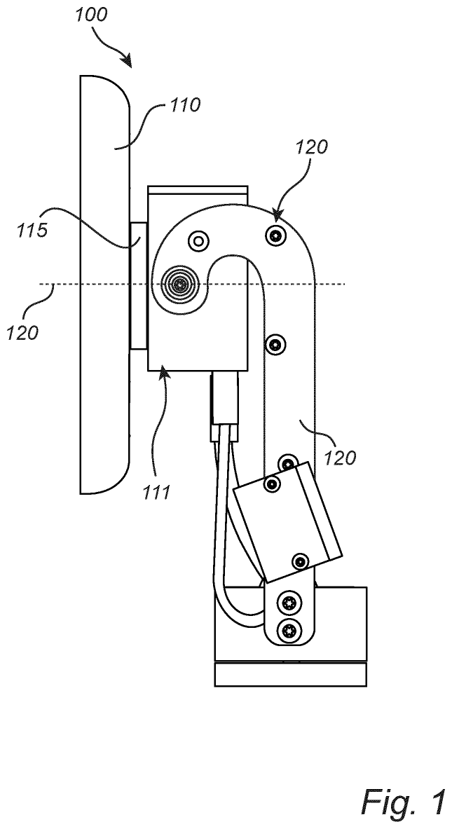

In one exemplary embodiment, as illustrated in FIGS. 1-3, a label applicator pad assembly 100. FIG. 1 is a sideview of the pad assembly 100.

The pad assembly 100 comprises a pad 110, a main frame 111, a bracket 115, holders 120, coupling arrangements 130 and 140, fastening means 160 and bearings 150. The pad assembly 100 of this example can be supported by a carrier arm (not shown).

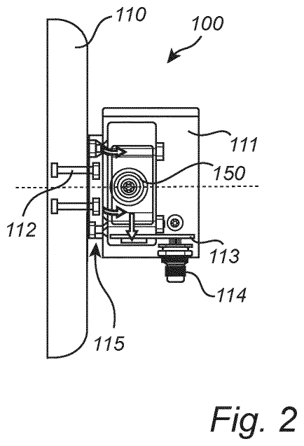

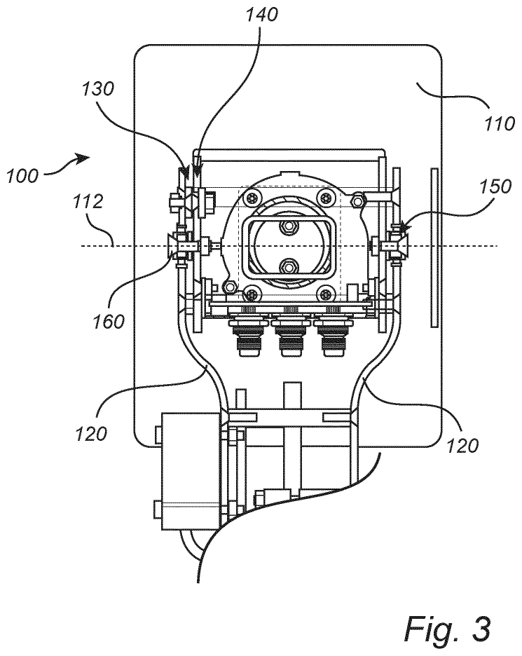

FIG. 2 is part of the pad assembly 100 with a section of the frame 111 removed. FIG. 3 is a right-hand side view of the pad assembly 100 of FIG. 1 and parts of the frame 111 and carrier arm removed.

The pad assembly 100 is attached to the holders 120 and provided with one axis of rotation 112. This can be achieved using bearings or ball bearings 150, or any other supporting means allowing rotation/pivoting of the frame 111 attached to the holders 120. A pair of magnets 130 and 140 are arranged substantially contactless in an aligned position and at a distance from the rotation axis 112 whereby the magnets facilitate both a spring-load effect and a home position. The magnet 130 is mounted on the holder 120 and the magnet 140 (distanced from magnet 130) on the main frame 111, such that the pull force of the magnets causes the holder 120 and main frame 111 to pull towards each other. In this way a pulling effect is generated for the hinged label pad 110. Bearings 150 ensure that the two parts cannot come into contact with each other. Instead, there is one specific position where the pulling effect of the magnets 130 and 140 is strongest, and this position is designated as the “home position”.

The pulling effect is accomplished by two magnets 130 and 140 attracting each other. In one exemplary embodiment, two or several magnets may be arranged. In yet another exemplary embodiment, this may be accomplished by combination of one (or several) magnet and one (or several) ferromagnetic component. In one exemplary embodiment, the movement of the label applicator pad 110 is restricted, by means of a restriction arrangement such as blocking pins in the joint, in both directions from the home position to ensure that it is not too distanced from the magnetic pulling effect, allowing it to return to the home position after a label is applied onto the target.

The holders 120 are shaped with a curved holding section to which the frame 111 is connected. However, the holder may be shaped straight or any other shape suitable for the application.

The applicator pad bracket 115 is arranged between the pad 110 and the backing frame 111 and which in one exemplary embodiment can be made of plastic or aluminium with slots for attaching means, such as stainless-steel nuts 112 for durability. Cleary, other attachment means can also be used.

Thus, the assembly according to this embodiment provides a labelling arrangement, wherein the label pad 110 can be connected to the carrier arm, for example to move lean forward/backward and/or rotate clockwise/counterclockwise comprising one axis of rotation.

The frame may also house electronics, such as PCB 113 and connectors 114 for various devices attached to the arm and/or housed by the frame.

In one exemplary embodiment, entire structure can be provided with passages, i.e., apertures on the surface of the pad and opening in the base of the pad and channel through the frame and allowing air from the label pad to pass unrestricted up through it.

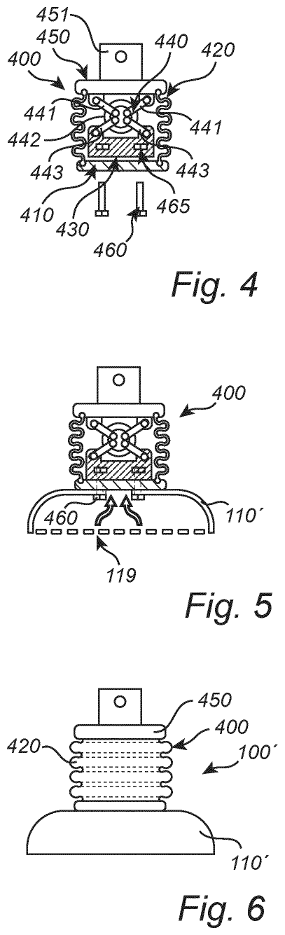

In one exemplary embodiment, the applicator pad may be connected to a holder or arm using a swivel joint 400 as depicts schematically in FIG. 4. In FIG. 4, a cross sectional view of the joint 400 is shown. FIG. 5 is a schematical sectional view of the joint 400 connected to an applicator pad 110′. FIG. 6 is a schematical side view of the joint 400 and applicator pad 110′.

The joint 400 comprises at least a first holder 410, an outer wall 420, an inner holder 430, a chain mechanism 440, and a second holder 450. In the plane of the drawing, the first holder 410 is the lower holder and the second holder 450, the upholder. The chain mechanism 400 may be arranged on at least two sides of the substantially rectangular holder 450 and in this embodiment the chain mechanism is mounted on four sides the holder.

The outer wall 420 is formed as a spring/bellow comprising flexible substantially U-shaped convolution, which can be cubic, cylindric or any other suitable shape surrounding the pad connection portion and the second (upper) holder 450. The end portions 421 of the wall 420 may comprise a thickening that can be inserted and secured into recesses in the first and the second holders.

The second holder 450 may comprise a connector portion 451 to connect the joint to, for example an applicator arm (not shown). The connector portion 451 may comprise a substantially tubular structure.

The chain mechanism 440 comprises side links 441, 443 connected a centre link 442 at each side. Each side link 441 is mounted to a holder portion shaped as a hole or a loop at the second holder and each link 443 is mounted to a holder portion shaped as hole or a loop on the inner holder. The holders may have a substantially square or circular shape and the holder portions may be arranged in corners of the holders.

In one exemplary embodiment, the joint 400 may be 3D-printed. The first holder 410 is not in direct contact with the inner holder 430. When the two parts, first and the inner holders 410 and 430, are attached and tightened together with for example attachments means, such as screws 460 and nuts 465, the outer spring/bellow 420 is compressed, causing the chain mechanism 440 to be stretched, which in turn causes the lower outer holder 410 to be directed to a defined home position. The chain mechanism guides in three dimensions. The label pad 110′ is connected directly or indirectly to the first holder 410 and the inner holder 430. According to FIG. 5 this is achieved for example using the screws 460 extending through the three parts, i.e., a base of the pad 110′, the first holder 410 and the inner holder 430. A nut 465 can be inserted into a designated space in the inner holder 430 to receive the screw 460 and provide attachment.

In operation, when the assembly hits the application target, the outer spring/bellow 420 is compressed and the chain mechanism 440 is slacked, which gives the first holder 410 freedom to move and adopt to the application surface.

In one exemplary embodiment, the entire structure can be provided with passages, i.e., apertures 119 on the surface of the pad and opening in the base of the pad and channel through the inner holder 430, allowing air from the label pad to pass unrestricted through it. The outer spring/bellow 420 not only acts as a spring but also as a bellow preventing the air from leaking.

Clearly, the joint may be manufactured in other ways than 3D-printing, such as moulding or casting.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

Software and web implementations of various embodiments of the present invention can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the inventive concepts being set forth in the following claims.

1. A label applicator pad assembly (100, 100′) comprising: an applicator pad (110,110′), a support structure (120, 450), a joint (150, 400) provided between the support structure and the applicator pad, and a mechanism operable between the applicator pad and the support structure and actionable in a direction opposite to the joint configured to provide a home position for the applicator pad.

2. The label applicator pad assembly (100) of claim 1, wherein the joint comprises a pivoting joint, and the mechanism comprised a pair of attracting magnets (130, 140) arranged between the applicator pad and the support structure at a distance from the pivoting joint configured to provide a counter action in opposite direction of the pivoting direction provided by the joint, said home position is defined when the magnets are at closest distance from each other.

3. The label applicator pad assembly (100) of claim 2, comprising restriction means restricting the movement of the label applicator pad (110) is restricted to be distanced from the magnetic pulling effect.

4. The label applicator pad assembly (100′) of claim 1, wherein the joint is a multi-directional swivel joint, and the mechanism further comprises a flexible member (440) arranged between the applicator pad and the support structure configured to provide a counter action in opposite direction of the swiveling direction provided by the joint, wherein said home position is defined when the flexible member is decompressed.

5. The label applicator pad assembly (100′) according to claim 4, wherein the flexible member comprises a chain structure (440) comprising links (441) connected to a centre link (442) and corner sections of the support structure (450).

6. The label applicator pad assembly (100′) according to claim 4 or 5, said flexible member connects said support structure to a portion of said label applicator pad at two sides.

7. The label applicator pad assembly (100′) according to any of claims 4 to 6, wherein the chain mechanism is configured to guide in three dimensions.

8. The label applicator pad assembly (100′) according to any of claims 4-7, further comprising a flexible outer wall structure (420).

9. The label applicator pad assembly (100′) according to claim 8, wherein the flexible outer wall structure is formed flexible substantially U-shaped convolutions.

10. The label applicator pad assembly (100′) according to claim 8 or 9, wherein the outer wall is substantially cubic or cylindric.

11. The label applicator pad assembly (100′) according to any of claims 4 to 10, wherein the joint (400) is 3D-printed.

12. The label applicator pad assembly (100′) according to any of claims 8 to 11, wherein the support structure is connected to a second support structure (430) coupled to the flexible member and the second support structure is attached to a label applicator pad connector (410) coupled to said wall structure.

13. The label applicator pad assembly (100′) according to claim 8, wherein said wall structure is configured to be compressed when the second support structure and the label applicator pad connector are assembled, causing the chain mechanism (440) to be stretched, causing the support structure to be directed to the home position.

14. The label applicator pad assembly (110′) according to any of claims 8 to 13, wherein in operation, the wall structure is configured to compress when the label applicator pad assembly touches an application target for applying a label and the chain mechanism is configured to slack, enabling the support structure to move and adopt to the application surface.

15. The label applicator pad assembly according to any of claims 1 to 12, wherein the label applicator pad comprises apertures (119) on the surface of the label applicator pad and an opening in a base section and channels through the support structure.
